(19) United States
(12) Patent Application Publication
(10) Pub. No.: US 2009/0025046 A1
(43) Pub. Date: Jan. 22, 2009

(54) Hybrid architecture for media services

(75) Inventors: Prasanna Ganesan, Menlo Park, CA (US); Tony Miranz, Palo Alto, CA (US)

Correspondence Address: SHEMWELL MAHAMEDI LLP, 4880 STEVENS CREEK BOULEVARD, SUITE 201, SAN JOSE, CA, 95129-1034, US

(73) Assignee: WOND, LLC

(21) Appl. No.: 11/269,462

(22) Filed: Nov. 7, 2005

Related U.S. Application Data
(63) Continuation-in-part of application No. 11/075,573, filed on Mar. 9, 2005.

(51) Int. Cl. H04N 7/173

(52) U.S. Cl. 725/91

(57) ABSTRACT

Techniques of providing media services based on a hybrid architecture are disclosed. The hybrid architecture is provided to take the benefits, features and advantages of both distributed architecture and client-server architecture. According to one aspect of the present invention, data pertaining to a title (e.g., a movie, a game, a data file or a piece of footage) is divided or organized into several segments that are distributed among boxes in service. General orders of titles being offered in a library are fulfilled by a group of selected client devices delivering respective segments to an ordering box. Special orders of certain programs (e.g., a live event or a rare title not included in the library) are fulfilled directly by at least a server. In addition, the server is configured to supply some of the segments to an ordering box or back up any one of the selected boxes designated to supply the needed data to an ordering box. Because of the inherent superior computing power and more bandwidth, the server may deliver more than one segment at a time.

### CROSS-REFERENCE TO RELATED APPLICATION

This is a continuation-in-part of co-pending U.S. application Ser. No. 11/075,573, entitled “Continuous data feeding in a distributed environment” and filed Mar. 9, 2005, and by at least one of the co-inventors herein.

### BACKGROUND

1. Technical Field

The present invention is generally related to multimedia delivery over the Internet. Particularly, the present invention is related to techniques providing media service based on a hybrid architecture taking the benefits, features and advantages of both client-server architecture and distributed architecture.

2. Description of the Related Art

FIG. 1 shows a video delivery system 100 that is commonly used for delivering video services over a network. The video delivery system 100 includes a video server 102 that is sometimes referred to as a head-end. Through a data network 104, the video server 102 can provide continuous, scheduled and video-on-demand (VOD) services to respective client machines 106-1, 106-2, . . . 106-n (i.e., its subscribers). Hence, the system 100 is a typical client-server architecture with one server 102 serving a plurality of client machines 106-1, 106-2, . . . 106-n. The server 102 is further coupled to a media storage device 112 that may be configured to store various media files (e.g., movies or news footage). The media storage device 112 must be on-line and must store and supply titles scheduled or demanded for delivery to any of the client machines 106-1, 106-2, . . . 106-n.

To ensure quality of service (QoS), the bandwidth requirement of the network path (e.g., 108-1, 108-2, . . . 108-n) to each of the client machines 106-1,106-2, . . . 106-n has to be sufficient. However, as the number of the subscribers continues to increase, the demand on the bandwidth of the backbone network path 110 increases linearly, and the overall cost of the system 100 increases considerably at the same time. If the server has a fixed bandwidth limit and system support capability, an increase in the number of subscribers beyond a certain threshold will result in slower transfer of data to clients. In other words, the transmission of the video data over the network 104 to the subscribers via the client machines 106-1, 106-2, . . . 106-n is no longer guaranteed. When the video data is not received in a client machine on time, the display of the video data may fail or at least become jittery.

To alleviate such loading problem to the video server 102, a video delivery system often employs multiple video servers as rendering farms, perhaps in multiple locations. Each of the video servers, similar to the video server 102, is configured to support a limited number of subscribers. Whenever the number of subscribers goes beyond the capacity of a video server or the bandwidth thereof, an additional video server needs to be deployed or additional bandwidth needs to be allocated. Subsequently, overall costs go up considerably when more subscribers sign up with the video delivery system 100.

U.S. patent application Ser. No. 11/075,573 discloses techniques of delivering media services among clients with a central server as a manager or regulator. U.S. patent application Ser. No. 11/075,573 has fundamentally resolved the bandwidth issues that are experienced in the client-server architecture and made an entire video delivery system independent from the number of the users. In contrast, U.S. patent application Ser. No. 11/075,573 may perform better with more users because more clients available to supply requested data means more bandwidth for servicing others, while the video delivery system 100 starts to hit its limits when the number of its users exceeds a certain number.

It is desirable to take benefits, features and advantages of the respective architectures described in FIG. 1 and U.S. patent application Ser. No. 11/075,573 to come up with what is referred to herein as a hybrid architecture for delivering media services. Thus additional features, benefits and advantages can be realized.

### SUMMARY

This section is for the purpose of summarizing some aspects of embodiments of the present invention and to briefly introduce some preferred embodiments. Simplifications or omissions in this section as well as the title and the abstract of this disclosure may be made to avoid obscuring the purpose of the section, the title and the abstract. Such simplifications or omissions are not intended to limit the scope of the present invention.

Broadly speaking, the invention relate to techniques for providing media services over data networks. The techniques described herein are related to providing media services based on a hybrid architecture taking the benefits, features and advantages of both distributed architecture and client-server architecture. The disclosed techniques may be performed alone or in any combination to provide a novel and unobvious system or a portion of a system. It should be understood that the techniques in combination yield an equally independently novel combination as well, even if combined in their broadest sense; i.e. with less than the specific manner in which each of the techniques has been reduced to practice.

According to one aspect of the present invention, data pertaining to a title is divided or organized into several segments that are distributed among boxes in service. General orders of titles being offered in a library are fulfilled by a group of selected client devices (e.g., boxes) delivering respective segments to an ordering box. Special orders of certain programs (e.g., a live event or a rare title not included in the library) are fulfilled directly by a server. In addition, the server is configured to supply some of the segments to an ordering box or back up any one of the selected boxes designated to supply the needed data to an ordering box. Because of its inherent superior computing power and more bandwidth, the server may deliver more than one segment at a time.

One of the features in the present invention is that the architecture offers the flexibilities of being relatively independent from the number of users while, at the same time, offering centralized management or services to the users. The present invention inherently distributes load among client devices in service by using the computing power and bandwidth collectively available at any time in the client devices.

Embodiments of the invention may be implemented in numerous ways, including a method, system, device, or a computer readable medium. Several embodiments of the invention are discussed below. In one embodiment, the invention provides a system for providing media services, the system comprises: a plurality of boxes, each allowing a user to order many titles in a library being offered in each of the boxes; at least a server configured to distribute segments for each of the titles to the boxes, none of the boxes receiving all of the segments per a title till the title is ordered, wherein after receiving a request for an ordered title from an ordering box, the server is configured to identify one or more of devices to provide at least one or more of the segments pertaining to the ordered title, and wherein the ordering box proceeds with a playback of a residing object while downloading the at least one or more of the segments from the one or more devices, and wherein the server is configured to provide streaming pertaining to a program to one or more of the boxes when requested.

According to another embodiment, the invention provides a system for providing media services, the system comprises a plurality of boxes, each allowing a user to order many titles in a library being offered in each of the boxes; at least a server configured to distribute segments for each of the titles to the boxes, none of the boxes receiving all of the segments per a title till the title is ordered, wherein after receiving a request for an ordered title from an ordering box, the server is configured to identify one or more of devices to provide at least one or more of the segments pertaining to the ordered title, and wherein the ordering box proceeds with a playback of a residing segment while downloading the at least one or more of the segments from the one or more devices, and wherein the server is configured to provide streaming pertaining to a program that is not originally in the library to one or more of the boxes by either a unicast protocol or a multicast protocol.

One of the objects, features, and advantages of the present invention is to provide media services based on a hybrid architecture taking the benefits, features and advantages of both a distributed architecture and a client-server architecture

Other objects, features, and advantages of the present invention will become apparent upon examining the following detailed description of an embodiment thereof, taken in conjunction with the attached drawings.

### BRIEF DESCRIPTION OF THE DRAWINGS

The invention will be readily understood by the following detailed description in conjunction with the accompanying drawings, wherein like reference numerals designate like structural elements, and in which:

FIG. 1 shows a video delivery system that is commonly used for delivering video services over a network, also referred to as a server-and-client architecture;

FIG. 2A shows a configuration of a distributed network system in accordance with an embodiment of the present invention;

FIG. 2B, according to one embodiment, a file is being organized or fragmented in terms of four segments;

FIG. 2C shows another embodiment in which a file is being organized or fragmented in terms of a header and four segments, where the header is always locally cached;

FIG. 2D shows a data stream representing a file or a majority of a file, the file is being divided into four segments;

FIG. 3A shows an exemplary architecture that combines both the traditional client and server architecture of FIG. 1 and the distributed architecture of FIG.2A.

FIG. 3B shows an exemplary source information shown as a map illustrating how a library of 5000 movie titles is distributed across N boxes;

FIG. 3C shows a source information map corresponding to FIG. 3B, where three other boxes are designated to supply the needed three segments that are together assembled with the locally cached segment to facilitate the playback of the ordered movie;

FIG. 4A shows an embodiment of an ordering box retrieving and assembling segments to support a playback of a selected movie; and

FIG. 4B shows an embodiment of an ordering box receiving streaming directly from a server.

### DETAILED DESCRIPTION OF THE INVENTION

The present invention is related to techniques of providing media services based on a hybrid architecture taking the benefits, features and advantages of both distributed architecture and client-server architecture. According to one aspect of the present invention, data pertaining to a title (e.g., a movie, a game, a data file or a piece of footage) is divided or organized into several segments that are distributed among boxes in service. General orders of titles being offered in a library are fulfilled by a group of selected client devices delivering respective segments to an ordering box. Special orders of certain programs (e.g., a live event or a less popular title not widely distributed across the client devices, or any title during periods of high demand in the system) are fulfilled directly by at least a server. In addition, the server is configured to supply some of the segments to an ordering box or back up any one of the selected boxes designated to supply the needed data to an ordering box. Because of its inherent superior computing power and more bandwidth, the server may deliver more than one segment at a time.

In the following description, numerous specific details are set forth to provide a thorough understanding of the present invention. The present invention may be practiced without these specific details. The description and representation herein are the means used by those experienced or skilled in the art to effectively convey the substance of their work to others skilled in the art. In other instances, well-known methods, procedures, components, and circuitry have not been described in detail since they are already well understood and to avoid unnecessarily obscuring aspects of the present invention.

Reference herein to “one embodiment” or “an embodiment” means that a particular feature, structure, or characteristic described in connection with the embodiment can be included in at least one implementation of the invention. The appearances of the phrase “in one embodiment” in various places in the specification are not necessarily all referring to the same embodiment, nor are separate or alternative embodiments mutually exclusive of other embodiments. Further, the order of blocks in process, flowcharts or functional diagrams representing one or more embodiments do not inherently indicate any particular order nor imply limitations in the invention.

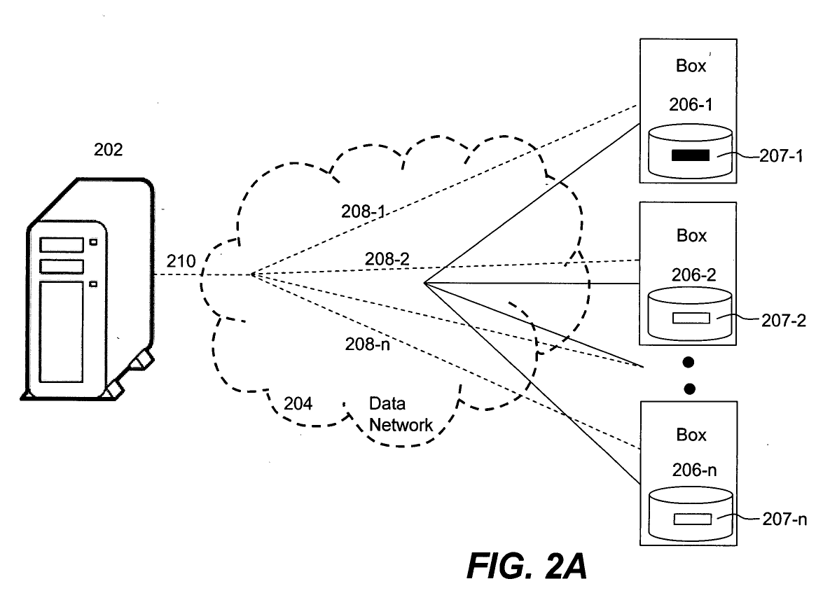

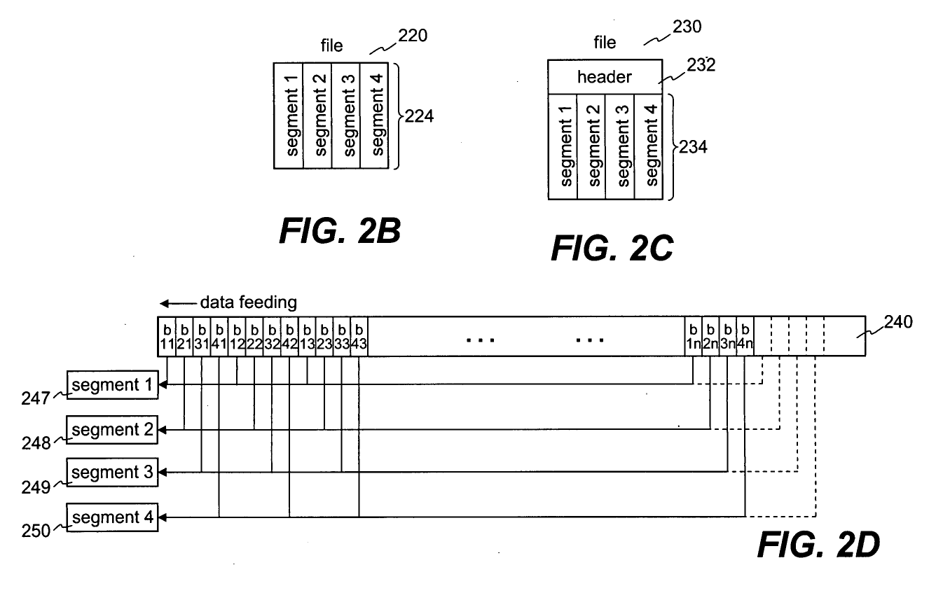

Embodiments of the present invention are discussed herein with reference to FIGS. 2A-4B. However, those skilled in the art will readily appreciate that the detailed description given herein with respect to these figures is for explanatory purposes only as the invention extends beyond these limited embodiments.

Shown as FIG. 2A of U.S. patent application Ser. No. 11/075,573, FIG. 2A shows an exemplary configuration 200 of a distributed network system 100. It will be appreciated that the entire network may comprise multiple of such network systems 100, for example, one for each box of a particular type, size, content, etc.

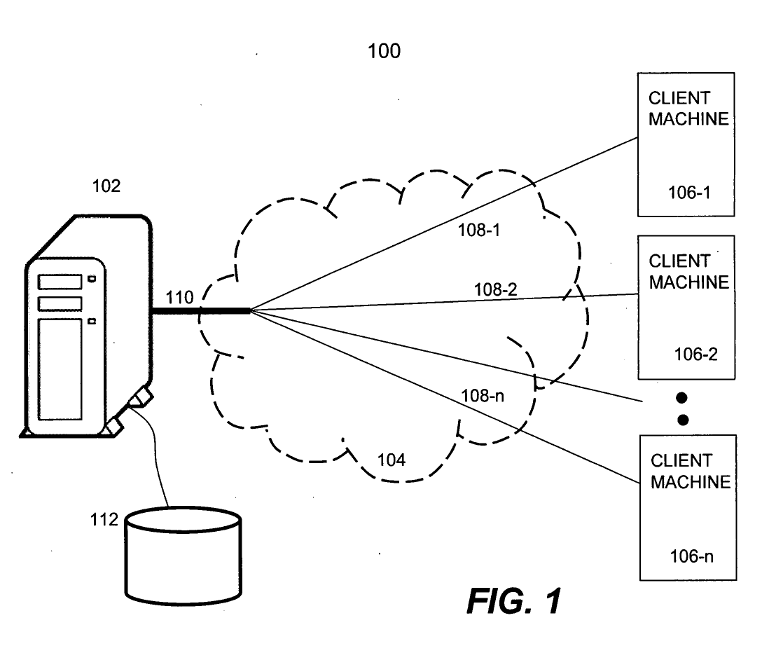

A server 202, presumably managed and/or populated by a service provider, is configured to handle the delivery of video (or multimedia) services to users via local machines or boxes 206-1, 206-2, . . . 206-n. Different from the video server 102 of FIG.1 that delivers video data to a subscriber upon receiving a request therefrom, the server 202 is not responsible for delivering the content in response to a request from a user, and instead is configured to provide source information as to where and how to retrieve at least some of the content from other boxes. In other words, the server 102 of FIG. 1 requires the media storage device 112 to provide the content when any of the client machines 106-1, 106-2, . . . 106-n is being serviced, while the server 202 does not need necessarily a media storage device to provide the content. Instead, some of the boxes 206-1, 206-2, . . . 206-n are respectively configured to supply part or all of the content to each other.

According to one embodiment, when fulfilling a request from a local machine or a box (e.g., 206-1), communication between the server 202 and the box 206-1 over the network paths 208-1 and 210 may be limited to small-scale requests and responses (e.g., of small size and very short). A server response to a request from a box may include source information (e.g., identifiers), authorization information and security information. Using the response from the server 202, the box may be activated to begin playback of a title (e.g., 207-1). Substantially at the same time, the box may initiate one or more requests to other boxes (e.g., 206-2 and 206-n) in accordance with the source identifiers to request subsequent portions of the title (e.g., 207-2 and 207-n). Assuming proper authorization, the requesting box receives the subsequent portions of the data concurrently from the other boxes. Because of box-to-box communication of content, the bandwidth requirement for box-to-server communications over the network paths 208-1 and 210 is kept low and typically short in duration. In the event there are a large number of user boxes issuing playback requests substantially at the same time, the bandwidth of the backbone path 210 should be sufficient to avoid noticeable or burdensome delay.

The contents available in a library being offered in any of the boxes 206-1, 206-2, . . . 206-n are originally provided by one or more content providers. Examples of the content providers include satellite receivers, television relay stations, analog or digital broadcasting station, movie studios and Internet sites. Depending on implementation, the contents may be initially received or originated in the server 202. Instead of maintaining and managing the content in a large storage device, the server 202 is configured to distribute the content or files to a plurality of local machines registered with the server 202. The boxes 206-1, 206-2, . . . 206-n shown in FIG. 2A are examples of local machines in service. Unless there is a need for a backup copy, the server 202 at any time has no need to keep a copy of the content. On the other hand, unless there is a special need to keep a complete copy of an extremely high-demand title in a box, none of the boxes in service has a complete copy of a title until an order is placed. Consequently, with embedded security in the distributed objects, some embodiments of the present invention may alleviate the concern of electronic piracy and widespread distribution (e.g., by hacking or illegal duplication).

For convenience, it is assumed herein that a file pertaining to a title is played back when the title is selected and ordered by a user. When an order for a title is placed, a corresponding file must be available for playback. One of the features in the system 200 is that a file, or at least a portion thereof, regardless of its size, can be accessed instantaneously, thereby realizing instantaneous VOD. According to one embodiment, where a file is 840 Mbytes on average and a box includes a storage capacity of 300 Gbytes, a system may offer a large library of titles (e.g., 5000) for access at any time instantly. In the prior art, if the files for the titles must be stored in advance to offer instantaneous playback, the local storage of a box would have to have a capacity of 4,000 Gbytes, consequently, rendering instantaneous VOD economically impractical.

According to one aspect of the present invention, only a beginning portion (referred to as a “header”) and possibly one or more tail segments of a file are locally cached in a box. Such locally cached segments are referred to as residing objects or segments, while segments not residing locally are referred to as distributed objects or segments. When a title is selected, the header of the corresponding file is instantly played back. During the time the header is being played, the distributed objects corresponding to the title are retrieved simultaneously from other boxes. When the header is finished, the received parts of the distributed segments being streamed in from other boxes is combined with residing segments for the title, if any, to enable a continuous playback. Depending on the popularity and concurrent demand for a particular title, the number of residing objects may be increased or decreased to control the dependency of each box on other boxes for playback. Typically, the more residing objects for a title a box has, the more distributed copies of the title there are in the entire system and thus the less dependency of the ordering box on the other boxes.

In one embodiment, the header is always played first to ensure instant playback. In another embodiment, the header size is reduced to zero, in which case, a time-fill program is played first to provide a time frame that is sufficient enough to fetch and assembly the beginning data portion of the segments either locally available or from other boxes. Depending on implementation, the time-fill program may include one or more trailers related to the title being ordered, various notifications/updates or commercial programs. The time-fill program may be locally configured. In one embodiment, the time-fill program is provided to give a time frame in which data being fetched from one or more other devices can be stabilized. In another embodiment, the time-fill program provides a platform for sponsors that hope to display their respective programs to audience. Orders or slot positions for these programs in a time-fill program may be auctioned.

Referring to FIG. 2B, there shows an embodiment in which a file 220 is being organized or fragmented in terms of four segments 224. In general, the file 220 representing a collection of all data pertaining to a title may be divided into any number of segments in consideration of a required transmission rate (e.g., related to the encoding and decoding rates for successful playback), and the minimum uploading and downloading capabilities of a network. FIG. 2C shows another embodiment in which a file 230 is being organized or fragmented in terms of a header 232 and four segments 224, where the header 232 is always locally cached. One of the advantages of having a header locally cached is to facilitate an instantaneous playback after a movie is order. While the header is being played back, the needed segments are retrieved from other designated boxes. It can be appreciated the length of a header may be predefined or dynamically determined to provide a time buffer (e.g., 5 minutes) sufficiently to retrieve part of the data from the distributed segments for assembling with that of any locally cached segments, if any. As a result, an instantaneous VOD system may be realized.

Regardless whether a header is used or not, a file or a majority of a file will be fragmented and the segments are distributed among the boxes in service. According to one embodiment, given a required transmission rate (e.g., 1 megabit per second or 1 Mbps), the minimum uploading and downloading speeds of a network are considered to determine a number that defines the segmentation, and thus the dependency on other boxes and the support for concurrent demands of a particular title.

It is assumed that a minimum uploading speed is U and a required transmission rate is D, and D/U=K<k, where k is the smallest integer greater than K. In one embodiment, a file or a majority of a file is preferably divided into k segments to optimally utilize the uploading speed of U, assuming that the downloading speed is at least k times faster than the uploading speed. For example, in a POTS-based DSL network for residential areas, the required transmission may be about 1.0 Mbps while the uploading speed may be about 300 kbps. Hence, k=4. Assuming that an ordering box has a downloading speed four times the uploading speed of the other boxes, up to four segments in other boxes can be downloaded concurrently across the network as streaming into the ordering box without interruption.

FIG. 2D shows a data stream 240 representing a file or a majority of a file. The file 240 is divided into four segments 247-250. The segments 247-250 are created or formed by respectively sampling the file in a decimated manner. As a result, each of the segments includes a plurality of data blocks. Depending on an exact data length of the file 240, an n-th data block in each of the segments 247-250 is four successive data blocks in the file. In one embodiment, a data block comprises a chunk of data, for example, 256 Kbytes or 1 Mbyte.

As shown in FIG. 2D, the data stream 240 is expressed in data blocks as follows: b11, b21, b31, b41, b12, b22, b32, b42, b13, b23, b33, b43, . . . b1n, b2n, b3n, b4n. With the decimated sampling, the four segments 247-250 obtained can be respectively expressed as follows:
Segment 1={b11, b12, b13, b14 . . . };
Segment 2={b21, b22, b23, b24 . . . . };
Segment 3={b31, b32, b33, b34 . . . }; and
Segment 4={b41, b42, b43, b44 . . . }.

It should be noted, however, a header, if used, includes data blocks that must be consecutive so that an instantaneous playback of the header is possible. It is evident that the data blocks in the segments are non-consecutive or interlaced.

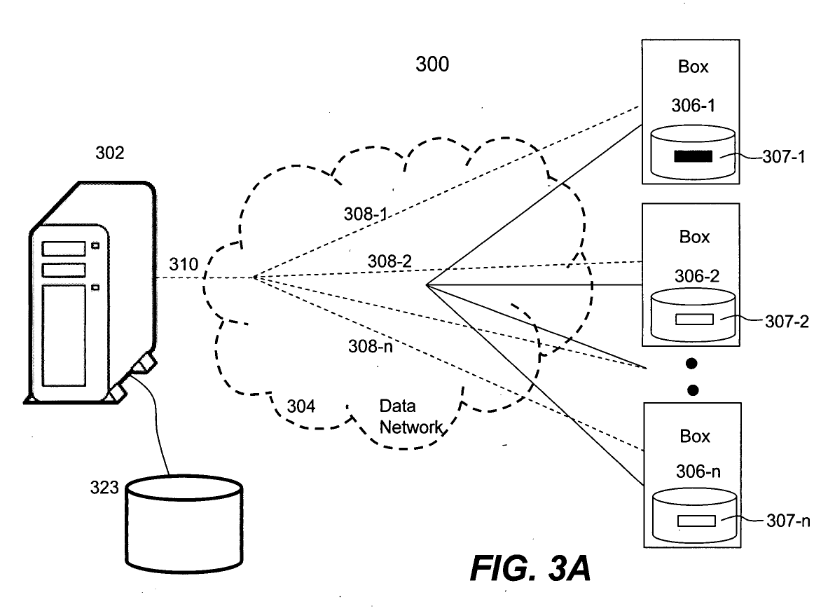

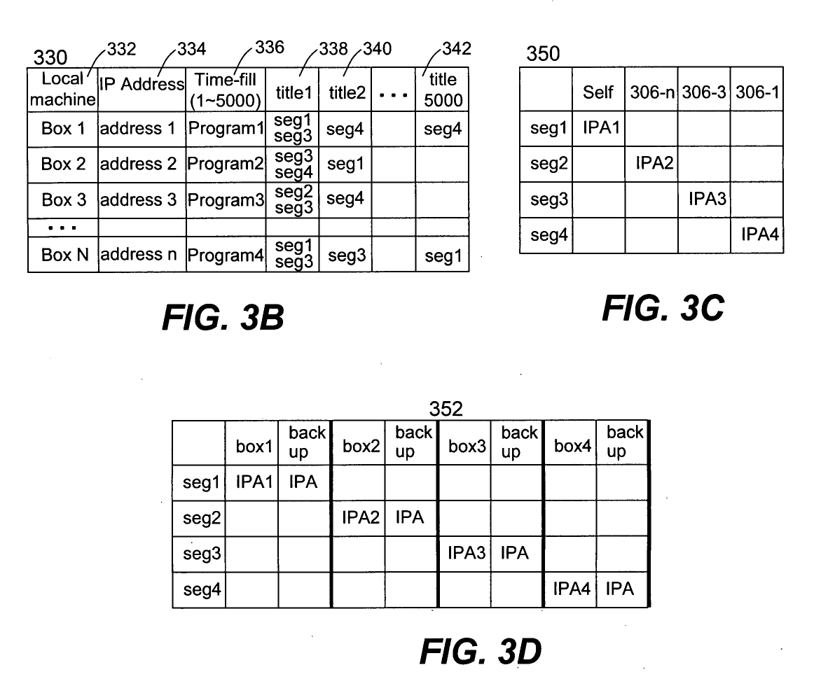

Referring now to FIG. 3A, it shows, according to one embodiment of the present invention, an architecture 300 that combines both the traditional client-server architecture of FIG. 1 and the distributed architecture of FIG. 2A. One of the features, benefits and advantages of the architecture 300 is the underlying mechanism of using the computing capacity as well as the bandwidth in the client side to deliver media services while, at the same time, providing centralized services.

For example, the architecture 300 may be configured to deliver non-prerecorded programs such as live broadcasts by a multicasting protocol. The server 302 receives orders from some of the subscribers (e.g., for boxes 306-1 and 306-n) for a broadcasting event. When the event comes, the server 302 receives a streaming feed from a source (e.g., a televised site). The streaming is then delivered by the server 302 via the network path 310 to 308-1 and 308-n to the ordering boxes 306-1 and 306-n. As the subscriber for the box 306-2 did not order the event, the box 306-2 will not receive the streaming from the server 302. It can be appreciated that the number of recipients for the program does not affect the performance of the server 302 or demands higher bandwidth because the program is being multicast to the ordering boxes.

The architecture 300, at the same, allows non-interrupted media services among the boxes. Similar to the description for FIG. 2A, segments for each title in a library are distributed among the boxes in service. When the box 306-1 is used to order one of the titles in a library, the request is sent to the server 302 via the network path 308-1 and 210. The server 302 is configured to determine which other boxes are most appropriate to be the suppliers for providing the distributed segments. Either the server 302 causes the suppliers to contact the ordering box 306-1 to receive the needed segments or the ordering box 306-1 initiates communication with the suppliers upon receiving a response form the server 302, where the response includes information about the suppliers. In one embodiment, the information includes designation information (e.g., network addresses) as to who are the suppliers, security information as to how to decrypt the data, and other information to facilitate the playback of the ordered title.

FIG. 3B shows exemplary source information shown as a map 330 illustrating how a library of 5000 movie titles is distributed across N boxes. Column 332 lists all boxes in service. Each box is assigned a unique identifier for identification. Information in the column 332 may be viewed as the identifiers for the boxes in service. For example, box 1 is assigned a unique identifier of “Box 1” or a sequence of alphanumeric characters. The column 334 lists a corresponding IP address for each of the boxes listed in column 332. The Column 336 lists predetermined time-fill programs for all titles in the library. Depending on implementation, the time-fill programs may be identical or each of the time-fill programs is self-configured in accordance with what has been ordered. The column 338 lists what segments for title1 are residing in each of the boxes, assuming title1 is required to have two segments cached in each box. The column 340 lists what segment for title2 is residing in each of the boxes, assuming title2 is required to have one segment cached in each of the boxes. The column 342 lists what segment for title5000 is in a selected set of boxes, assuming title5000 is required to have one segment in these selected boxes. As a result, all segments in a box may be uniquely addressed for uploading to another box or playback of an ordered title locally.

FIG. 3C shows a source information map 350 corresponding to FIG. 3B. There are three other boxes 306-n, 306-3 and 306-1 designated to supply three needed segments that are together assembled with a locally cached segment to facilitate the playback of the ordered movie. It can be appreciated that relying on multiple sources to retrieve distributed segments to support a playback can be advantageously used in the architecture of current networks where the downloading bandwidth is typically a multiple of the uploading bandwidth.

FIG. 3D shows exemplary source information with backup boxes in a table 352 that includes a backup identifier (shown as an IP address) for each of the designated boxes. Should one of the boxes fail to respond to the request for a segment from the ordering box or the segment cannot be received correctly, the backup IP address is immediately called upon to switch to the corresponding backup box that is available to provide or continue to provide a segment that the originally designated box fails to provide.

Referring now back to FIG. 3A, It can be appreciated that at any time the server 302 may designate itself to be one of the suppliers to an ordering box. In other words, a supplier provided to an ordering box can be either another box in the network or the server itself. According to one embodiment, when the supplier is a server, it is capable of supplying more than one segment. Although it is possible for a designated box to supply more than one segment for a title at a time to an ordering box, it is preferable that a server is configured to do so because the server inherently has more computing power and bandwidth than a single box does. According to one embodiment, the server may provide only a portion of a segment in order to complement a supplier that provides another portion of the segment in case the supplier cannot upload the segment at a sufficiently high rate. According to one embodiment, the server may attempt to designate client boxes as suppliers for a title but may designate itself as a back-up box in case an originally designed client box fails in the process.

In one embodiment, when a server is designed to be one of the suppliers to service an ordering box, the server is not necessarily the one that provides the designation information. A service provider may deploy several servers, each is designated to cover a specific area in accordance with one or more specification (e.g., popularity, geography, demographics, and/or like criteria).

According to one embodiment, the server 302 is configured to provide titles that are not widely distributed among the boxes in service. It is understood that the distributed architecture as described in FIG. 2A can provide a library with a large number of titles in a box with a limited capacity of storage. These titles are presumably popular among the subscribers. However, there may be some less popular title for which the overhead of storing many copies of its segments on different boxes may be too high, or for which the number of copies available in the network may be insufficient to address a temporary spike in demand for that title. In addition, there may be many titles that are newly introduced into the library and that have not yet been seeded into the boxes in the field. The server 302 can be configured to fulfill the need for serving such titles. According to one embodiment, a storage space 323 is provided to store data related to such rare or newly introduced titles that are not included in a library being offered. Streaming pertaining to such titles may be provided to an ordering box, in which case the data is provided by a unicast protocol. According to one embodiment, the server 302 is configured to provide any title in the library during periods of high demand in the system when there are an insufficient number of client boxes to service all the requests for different titles in the system.

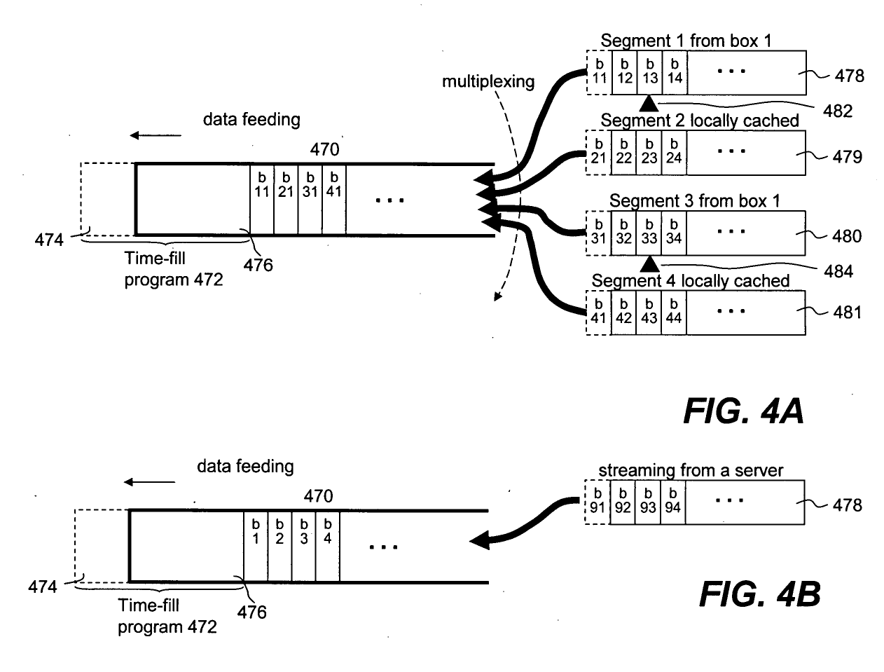

Referring now to FIG. 4A, there shows an embodiment of an ordering box retrieving and assembling segments to support a playback of a selected movie. If all segments are streaming at predetermined minimum speeds, then, at 456, portions of the segments locally stored and the portions of the segments being streamed in are multiplexed into a buffer as shown in FIG. 4A. A portion 474 of the time-fill program 472 has been played out of the buffer 470. The remaining portion 476 of the time-fill program 472 is yet to be played. At the same time, the streaming of segments 478 and 480 is being fed into the buffer 470. Segments 478-481 (including the segments locally stored and the segments being streamed in) are multiplexed into the buffer 470. More specifically, a block of data from segment 1, a block of data from segment 2, a block of data from segment 3 and a block of data from segment 4 are multiplexed and successively fed into the buffer 470. As a result, the original order of the data is restored and the remaining portion of the file pertaining to the title is assembled.

To facilitate the continuation of a data stream, each of the pointers 482 and 784 is used to remember where the data block of a segment is being fed or about to be fed to the buffer 470. In the event, the segment being fetched from a box is interrupted and a backup box needs to step in, the ordering box knows exactly where to start fetching the segment from where it was interrupted in accordance with the pointer. Likewise, similar pointers (not shown) may be provided to remember where the data block of the locally cached segment is being fed or about to be fed to the buffer 470. In the event, the ordering box needs to be reset or is suddenly powered off and back on, these pointers can facilitate the continuation of the playback of the ordered movie.

FIG. 4B shows an embodiment of an ordering box receiving streaming directly from a server. Different from the multiplexing operation shown in FIG. 4A, the ordering box is configured to buffer the data of the streaming into the buffer 470 that is provided to minimize any possible instability or interruption of the streaming. In operation, once an order is placed, a time-fill program 472 is instantly played. At the same time, a data sequence from a server is being fetched and put into the buffer 470. As soon as the time-fill program 472 is done, the buffered portion of the data is started. Not shown in FIG. 4B, data pointers may be used in FIG. 4B to facilitate the continuation of the playback of the data in case the ordering box is accidentally out of operation and turned back on.

The foregoing description of embodiments is illustrative of various aspects/embodiments of the present invention. Various modifications to the present invention can be made to the preferred embodiments by those skilled in the art without departing from the true spirit and scope of the invention as defined by the appended claims. Accordingly, the scope of the present invention is defined by the appended claims rather than the foregoing description of embodiments.

We claim:

1. A system for providing media services, the system comprising:
a plurality of boxes, each allowing a user to order many titles in a library being offered in each of the boxes;
at least a server configured to distribute segments for each of the titles to the boxes, none of the boxes receiving all of the segments per a title till the title is ordered, wherein after receiving a request for an ordered title from an ordering box, the server is configured to identify one or more of devices to provide at least one or more of the segments pertaining to the ordered title, and
wherein the ordering box proceeds with a playback of a residing segment while downloading the at least one or more of the segments from the one or more devices, and
wherein the server is configured to provide streaming pertaining to a program to one or more of the boxes when needed.

2. The system of claim 1, wherein the streaming is multicast to the one or more boxes.

3. The system of claim 2, wherein the program is a live event or started at a specific time.

4. The system of claim 2, wherein the program is not included in the library to be access at any time.

5. The system of claim 1, wherein the streaming is unicast to the one or more boxes.

6. The system of claim 5, wherein data pertaining to the program is stored in the server only.

7. The system of claim 1, wherein the residing object is a time-fill program that runs for a predefined time during which part of the segments are fetched into a buffer and ready to be executed as soon as the time-fill program is finished.

8. The system of claim 1, wherein the one or more devices are some of the boxes excluding the ordering box.

9. The system of claim 8, wherein an additional set of devices including some of the boxes are identified to back up the one or more devices should any one of the one or more devices fail to supply any one of the segments.

10. The system of claim 9, wherein the additional set of the devices includes the server that replaces one of the one or more devices originally identified to supply the segments.

11. The system of claim 1, wherein the one or more devices include the server and some of the boxes excluding the ordering box.

12. The system of claim 11, wherein the server is configured to supply more than one of the segments to the ordering box at a time.

13. The system of claim 1, wherein each of the segments includes non-consecutive data blocks.

14. The system of claim 13, wherein the segments must be multiplexed to form a data sequence to be executed.

15. A system for providing media services, the system comprising:
a plurality of boxes, each allowing a user to order many titles in a library being offered in each of the boxes;
at least a server configured to distribute segments for each of the titles to the boxes, none of the boxes receiving all of the segments per a title till the title is ordered, wherein after receiving a request for an ordered title from an ordering box, the server is configured to identify one or more of devices to provide at least one or more of the segments pertaining to the ordered title, and
wherein the ordering box proceeds with a playback of a residing segment while downloading the at least one or more of the segments from the one or more devices, and
wherein the server is configured to provide streaming pertaining to a program that is not originally in the library to one or more of the boxes by either a unicast protocol or a multicast protocol.

16. The system of claim 15, wherein data pertaining to each of the titles in the library is distributed among the boxes while data pertaining to the program is centrally stored or received in the server.

17. The system of claim 15, wherein the program is a live event that is delivered to some of the boxes by the multicast protocol.

18. The system of claim 15, wherein the program is retrieved by the server from another device and then relayed via the server by the unicast protocol to one of the boxes that has ordered the program.

19. The system of claim 15, wherein the system operates in a client-server architecture and a distributed architecture.
